(19) United States
(12) Patent Application Publication
(10) Pub. No.: US 2025/0227688 A1
(43) Pub. Date: Jul. 10, 2025

(54) INFORMATION TRANSMISSION METHOD AND APPARATUS, AND DEVICE

(71) Applicant: VIVO MOBILE COMMUNICATION CO., LTD., Guangdong (CN)

(72) Inventors: Tong ZHOU, Guangdong (CN); Hao WU, Guangdong (CN)

(21) Appl. No.: 19/090,670

(22) Filed: Mar. 26, 2025

Related U.S. Application Data
(63) Continuation of application No. PCT/CN2023/120927, filed on Sep. 25, 2023.

(30) Foreign Application Priority Data
Sep. 30, 2022 (CN) 202211216980.X

(51) Int. Cl. H04W 72/1263; H04W 24/10; H04W 64/00; H04W 72/044; H04W 72/40

(52) U.S. Cl. CPC H04W 72/1263; H04W 24/10; H04W 64/003; H04W 72/046; H04W 72/40

(57) ABSTRACT

This application discloses an information transmission method and apparatus, and a device. The information transmission method in embodiments of this application includes: receiving, by a first device, first information from a second device, where the first information includes at least one of the following: a first mapping relationship between an identifier of a mapping processing manner and a data collection requirement, and a first identifier, and the first identifier is used to indicate a target mapping processing manner; determining, by the first device, the target mapping processing manner based on the first information; and sending, by the first device, a first message to a third device, where the first message includes the first identifier and mapped data, and the mapped data is data obtained by processing collected data in the target mapping processing manner.

### CROSS-REFERENCE TO RELATED APPLICATIONS

This application is a continuation application of PCT International Application No. PCT/CN2023/120927 filed on Sep. 25, 2023, which claims priority to Chinese Patent Application No. 202211216980.X, filed on Sep. 30, 2022, which are incorporated herein by reference in their entireties.

### TECHNICAL FIELD

This application pertains to the field of communication technologies, and specifically relates to an information transmission method and apparatus, and a device.

### BACKGROUND

In a communication device, it is often necessary to obtain data provided by another communication device during operation. For example, in beam pair prediction, a peer communication device needs to provide detailed beam information, so that prediction accuracy can be improved. However, currently, data is directly transmitted between communication devices, that is, data is directly exposed. Consequently, security of data transmission between devices is relatively poor.

### SUMMARY

According to a first aspect, an information transmission method is provided, including:
receiving, by a first device, first information from a second device, where the first information includes at least one of the following: a first mapping relationship between an identifier of a mapping processing manner and a data collection requirement, and a first identifier, and the first identifier is used to indicate a target mapping processing manner;
determining, by the first device, the target mapping processing manner based on the first information; and
sending, by the first device, a first message to a third device, where the first message includes the first identifier and mapped data, and the mapped data is data obtained by processing collected data in the target mapping processing manner.

According to a second aspect, an information transmission method is provided, including:
sending, by a second device, first information to a first device, where the first information includes at least one of the following: a first mapping relationship between an identifier of a mapping processing manner and a data collection requirement, and a first identifier, and the first identifier is used to indicate a target mapping processing manner.

According to a third aspect, an information transmission method is provided, including:
sending, by a third device, a target data collection requirement; and
receiving, by the third device, a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

According to a fourth aspect, an information transmission apparatus is provided, including:
a receiving module, configured to receive first information from a second device, where the first information includes at least one of the following: a first mapping relationship between an identifier of a mapping processing manner and a data collection requirement, and a first identifier, and the first identifier is used to indicate a target mapping processing manner;
a determining module, configured to determine the target mapping processing manner based on the first information; and
a sending module, configured to send a first message to a third device, where the first message includes the first identifier and mapped data, and the mapped data is data obtained by processing collected data in the target mapping processing manner.

According to a fifth aspect, an information transmission apparatus is provided, including:
a first sending module, configured to send first information to a first device, where the first information includes at least one of the following: a first mapping relationship between an identifier of a mapping processing manner and a data collection requirement, and a first identifier, and the first identifier is used to indicate a target mapping processing manner.

According to a sixth aspect, an information transmission apparatus is provided, including:
a first sending module, configured to send a target data collection requirement; and
a receiving module, configured to receive a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

According to a seventh aspect, a communication device is provided, including a processor and a memory, where the memory stores a program or an instruction that can be run on the processor, and the program or the instruction is executed by the processor to implement the steps of the information transmission method on the first device side provided in the embodiments of this application.

According to an eighth aspect, a communication device is provided, including a processor and a communication interface. The communication interface is configured to receive first information from a second device, where the first information includes at least one of the following: a first mapping relationship between an identifier of a mapping processing manner and a data collection requirement, and a first identifier, and the first identifier is used to indicate a target mapping processing manner; the processor is configured to determine the target mapping processing manner based on the first information; and the communication interface is further configured to send a first message to a third device, where the first message includes the first identifier and mapped data, and the mapped data is data obtained by processing collected data in the target mapping processing manner.

According to a ninth aspect, a communication device is provided, including a processor and a memory, where the memory stores a program or an instruction that can be run on the processor, and the program or the instruction is executed by the processor to implement the steps of the information transmission method on the second device side provided in the embodiments of this application.

According to a tenth aspect, a communication device is provided, including a processor and a communication interface. The communication interface is configured to send first information to a first device, where the first information includes at least one of the following: a first mapping relationship between an identifier of a mapping processing manner and a data collection requirement, and a first identifier, and the first identifier is used to indicate a target mapping processing manner.

According to an eleventh aspect, a communication device is provided, including a processor and a memory, where the memory stores a program or an instruction that can be run on the processor, and the program or the instruction is executed by the processor to implement the steps of the information transmission method on the third device side provided in the embodiments of this application.

According to a twelfth aspect, a communication device is provided, including a processor and a communication interface. The communication interface is configured to: send a target data collection requirement; and receive a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

According to a thirteenth aspect, an information transmission system is provided, including a first device, a second device, and a third device. The first device may be configured to execute the steps of the information transmission method on the first device side provided in the embodiments of this application, the second device may be configured to execute the steps of the information transmission method on the second device side provided in the embodiments of this application, and the third device may be configured to execute the steps of the information transmission method on the third device side provided in the embodiments of this application.

According to a fourteenth aspect, a readable storage medium is provided, where the readable storage medium stores a program or an instruction, and the program or the instruction is executed by a processor to implement the steps of the information transmission method on the first device side provided in the embodiments of this application, or the steps of the information transmission method on the second device side provided in the embodiments of this application, or the steps of the information transmission method on the third device side provided in the embodiments of this application.

According to a fifteenth aspect, a chip is provided, where the chip includes a processor and a communication interface, the communication interface is coupled to the processor, and the processor is configured to run a program or an instruction to implement the information transmission method on the first device side provided in the embodiments of this application, or the information transmission method on the second device side provided in the embodiments of this application, or the information transmission method on the third device side provided in the embodiments of this application.

According to a sixteenth aspect, a computer program/program product is provided, where the computer program/program product is stored in a storage medium, and the computer program/program product is executed by at least one processor to implement the steps of the information transmission method on the first device side provided in the embodiments of this application, or the computer program/program product is executed by at least one processor to implement the steps of the information transmission method on the second device side provided in the embodiments of this application, or the computer program/program product is executed by at least one processor to implement the steps of the information transmission method on the third device side provided in the embodiments of this application.

### BRIEF DESCRIPTION OF DRAWINGS

FIG. 1 is a block diagram of a wireless communication system to which the embodiments of this application are applicable;

FIG. 2 is a flowchart of an information transmission method according to an embodiment of this application;

FIG. 3 is a flowchart of another information transmission method according to an embodiment of this application;

FIG. 4 is a flowchart of another information transmission method according to an embodiment of this application;

FIG. 5 is a structural diagram of an information transmission apparatus according to an embodiment of this application;

FIG. 6 is a structural diagram of another information transmission apparatus according to an embodiment of this application;

FIG. 7 is a structural diagram of another information transmission apparatus according to an embodiment of this application;

FIG. 8 is a structural diagram of another communication device according to an embodiment of this application;

FIG. 9 is a structural diagram of another communication device according to an embodiment of this application;

FIG. 10 is a structural diagram of another communication device according to an embodiment of this application; and

FIG. 11 is a structural diagram of another communication device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions.

These technologies can also be applied to applications other than an NR system application, such as a 6th generation (6G) communication system.

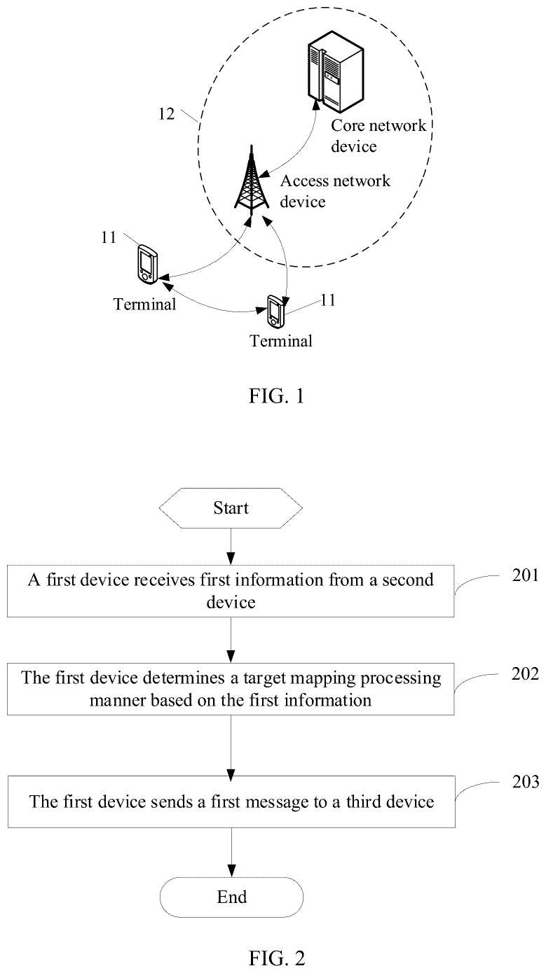

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. In addition to the foregoing terminal device, the terminal may be a chip in the terminal, such as a modem chip or a system on chip (SoC). It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that, in the embodiments of this application, only a core network device in an NR system is used as an example for description, and a specific type of the core network device is not limited.

With reference to the accompanying drawings, the following describes in detail an information transmission method and apparatus, and a device provided in the embodiments of this application by using some embodiments and application scenarios thereof.

Referring to FIG. 2, FIG. 2 is a flowchart of an information transmission method according to an embodiment of this application. As shown in FIG. 2, the method includes the following steps.

Step 201: A first device receives first information from a second device, where the first information includes at least one of the following: a first mapping relationship between an identifier of a mapping processing manner and a data collection requirement, and a first identifier, and the first identifier is used to indicate a target mapping processing manner.

The first device may be a network side device, such as a radio access network device or a core network device. In some implementations, the first device may be alternatively a terminal. In some implementations, the first device may be a mapping processing device.

The second device may be a network side device, such as a radio access network device or a core network device. In some implementations, the second device may be alternatively a terminal. In some implementations, the second device may be a mapping processing manner decision device.

In this embodiment of this application, a mapping processing manner refers to performing mapping processing on data, so as to avoid data exposure, so that processed data has higher security. In addition, the mapping processing may also be referred to as privacy-oriented processing, privacy processing, data mapping processing, information mapping processing, or the like. The mapping processing manner may also be referred to as a privacy-oriented processing manner, a privacy processing manner, a data mapping processing manner, an information mapping processing manner, or the like, which is not specifically limited thereto.

The first mapping relationship is used to indicate a mapping relationship between at least one data collection requirement and an identifier of a mapping processing manner. For example, a data collection requirement is in a one-to-one mapping relationship with an identifier of a mapping processing manner.

The first identifier may be an identifier of the target mapping processing manner. In addition, the first identifier may be referred to as a mapping identifier, a privacy-oriented identifier, a privacy processing identifier, a data collection identifier, a data acquisition identifier, a data processing identifier, or a data preprocessing identifier.

In addition, in this embodiment of this application, an identifier may be in a one-to-one correspondence with a mapping processing manner.

The target mapping processing manner may be a mapping processing manner indicated by the second device, or may be a mapping processing manner determined by the first device based on the first mapping relationship.

Step 202: The first device determines the target mapping processing manner based on the first information.

The determining, by the first device, the target mapping processing manner based on the first information may be determining the target mapping processing manner corresponding to the first identifier; or the determining, by the first device, the target mapping processing manner based on the first information may be determining the target mapping processing manner based on the first mapping relationship.

Step 203: The first device sends a first message to a third device, where the first message includes the first identifier and mapped data, and the mapped data is data obtained by processing collected data in the target mapping processing manner.

The third device may be a terminal. In some implementations, the third device may be alternatively a network side device, such as a radio access network device or a core network device. In some implementations, the third device may be a data collection device, that is, a device for collecting mapped data.

The mapped data may be that the first device performs mapping processing on the collected data in the target mapping processing manner to obtain the mapped data.

The collected data may be data collected by the first device. In some implementations, the collected data may be beam information.

It should be noted that data in this embodiment of this application may be alternatively information. For example, the mapped data may also be referred to as mapped information, and the collected data may also be referred to as collected information.

In this embodiment of this application, through the foregoing steps, the mapped data obtained by processing the collected data in the target mapping processing manner can be transmitted between the first device and the third device. In this way, direct exposure of data can be avoided, thereby improving security of data transmission between communication devices.

In an optional implementation, in a case that the first information includes the first mapping relationship, the determining the target mapping processing manner includes:
determining the target mapping processing manner based on the first mapping relationship and a target data collection requirement, where the target data collection requirement is a data collection requirement of to-be-collected data.

The data collection requirement may indicate a type, a quantity, and a collection configuration of data that needs to be collected.

The target mapping processing manner may be determined based on the data collection requirement, or the target mapping processing manner may be used to process the collected data collected based on the data collection requirement.

The target data collection requirement includes at least one of the following:
a to-be-collected data object and a quantity of pieces of to-be-collected data.

The to-be-collected data object may include at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight (LOS) distribution information of a cell; and
non-line-of-sight (NLOS) distribution information of a cell.

In some implementations, the width of the beam in the horizontal direction may be a 3 dB or 1 dB beam width of the beam in the horizontal direction, the width of the beam in the vertical direction may be a 3 dB or 1 dB beam width of the beam in the vertical direction, and the beam gain may be a beam gain centered on a beam direction with intervals of 5 degrees or 10 degrees.

The collection quantity may include at least one of the following:
a quantity of beams, a quantity of terminals, a quantity of network functions, and a quantity of cells.

In this implementation, the target mapping processing manner may be determined based on the first mapping relationship and the target data collection requirement, so that a mapping processing manner corresponds to a data collection requirement, thereby improving data processing performance.

Optionally, the determining the target mapping processing manner based on the first mapping relationship and the target data collection requirement includes:
determining the target mapping processing manner based on the first mapping relationship, the target data collection requirement, and a capability of the third device to process to-be-mapped data.

The capability of the third device to process the to-be-mapped data may be sent by the second device or the third device. The capability of the third device to process the to-be-mapped data may include at least one of the following:
a capability of whether to support processing of to-be-mapped data, a maximum supported quantity of pieces of data after mapping processing, and a supported value range after mapping processing. The foregoing information transmission method can improve security of data transmission between communication devices.

The determining the target mapping processing manner based on the first mapping relationship, the target data collection requirement, and a capability of the third device to process to-be-mapped data may be determining, in the first mapping relationship, the target mapping processing manner that corresponds to the target data collection requirement and that matches the capability of the third device to process the to-be-mapped data.

In this implementation, the determined target mapping processing manner may be matched with the capability of the third device to process the to-be-mapped data, thereby improving performance of data transmission between devices.

It should be noted that, in some implementations, the target mapping processing manner may be determined without considering the capability of the third device to process the to-be-mapped data. For example, a corresponding mapping processing manner in the first mapping relationship is a mapping processing manner generally supported by a communication device. Alternatively, in some scenarios, the capability of the third device to process the to-be-mapped data supports the target mapping processing manner by default.

Optionally, the target data collection requirement is a data collection requirement of the third device; and
the target data collection requirement is received by the first device and sent by the third device, or the data collection requirement is received by the first device and sent by the second device.

Being received by the first device and sent by the second device may be that the first device receives the data collection requirement that is of the third device and that is forwarded by the second device.

Optionally, in a case that the data collection requirement is received by the first device and sent by the third device, the first information includes the first mapping relationship; or
in a case that the data collection requirement is received by the first device and sent by the second device, the first information includes the first identifier.

In this implementation, the first device may determine the target mapping processing manner based on the first identifier sent by the second device. In addition, in a case that the target data collection requirement is sent by the second device, the first information may include the first identifier and the target data collection requirement.

In addition, the first device may further determine the target mapping processing manner based on the target data collection requirement of the third device and the first mapping relationship.

In some implementations, the second device may send the first mapping relationship to the first device in advance. The first device may determine the target mapping processing manner based on the data collection requirement of the third device and the first mapping relationship.

For example, if a data collection requirement includes a beam direction, it is determined to select a mapping processing manner 1, and an offset value is set to 1. If an information quantity is 100, a random sequence 1 is fixed. If an information quantity is 10, another random sequence is corresponding. For example, as shown in the following Table 1:

TABLE 1

| Information quantity | Random sequence |
|---|---|
| 10 | 1 4 3 5 7 9 8 6 2 10 |
| 11 | 1 4 3 5 7 11 2 10 9 8 6 |
| 12 | 5 7 11 2 12 1 4 3 10 9 8 6 |
| 13 | 5 13 1 4 3 10 9 8 7 11 2 12 6 |

In an optional implementation, the method further includes:
receiving, by the first device, a second mapping relationship, sent by the second device, between an identifier and a mapping processing manner.

The second mapping relationship may be a one-to-one correspondence between an identifier and a mapping processing manner.

It should be noted that, in some implementations, the second mapping relationship may be preconfigured or defined in a protocol.

In some implementations, the first device may determine the used target mapping processing manner based on the first identifier. For example, mapping processing manners include mapping manners 1 to 5. In this case, one mapping manner or a mapping manner combination is determined from the mapping manners 1 to 5 by using the first identifier, and a transformation operation involved in each mapping manner may be further determined.

For example, based on the first identifier, at least one of the following is determined:
the mapping manners 1 and 5 are used;
an offset value 100 used in the mapping manner 1; and
a shuffling operation: 4 3 1 5 6 7 8 2 used in the mapping manner 5.

100 is a parameter configuration of the mapping manner 1, and a transformation sequence 4 3 1 5 6 7 8 2 is a parameter configuration of the mapping manner 5. A combination of a plurality of mapping manners may be used for a data object. One mapping identifier may include mapping processing for a plurality of data objects. If a same mapping manner is used but different parameter configurations are used for one data object, there are different mapping identifiers.

In an optional implementation, the target mapping processing manner includes at least one of the following:
offset processing;
scaling processing;
function transformation processing;
multidimensional mapping processing;
shuffling processing; and
quantization mapping processing.

In some implementations, the target mapping processing manner is known to the first device but unknown to the third device. In this way, data security can be further improved, which is not limited thereto. For example, in some scenarios or implementations, the target mapping processing manner is known to the third device. For example, the first device and the third device are devices of a same type.

The offset processing may be performing offset processing on data based on an offset value, where the offset value is known to the first device, and is unknown or known to the third device.

The scaling processing may be performing scaling or amplification processing on data based on a scaling value, where a scaling multiple is known to the first device, and is unknown or known to the third device.

The function transformation processing may be performing an operation on data as a variable of a function, where the function used for transformation is known to the first device, and is unknown or known to the third device.

The multidimensional mapping processing may be mapping one piece of data to a plurality of pieces of data, where a mapping method is known to the first device, and is unknown or known to the third device.

The offset processing, scaling processing, function transformation processing, and multidimensional mapping processing may be shown in the following Table 2:

TABLE 2

| No | Mapping processing manner | Example |
|---|---|---|
| 1 | Offset processing (performing offset | Original value: 10 |
| | processing on a value) | Offset value: 100 |
| | | After offset processing: −90 |
| 2 | Scaling processing (performing | Original value: 100 |
| | scaling on a value) | Scaling value: 0.1 |
| | | After scaling: 10 |
| 3 | Function transformation processing | Original value: 10 |
| | (performing polynomial function | Transformation polynomial: |
| | change on a value) | f(x) = 2x\hat{ }3 + 5 |
| | | After transformation: 2005 |
| 4 | Multidimensional mapping | Original value: 10 |
| | processing (performing | Multidimensional mapping |
| | multidimensional mapping on a | (0.1x + 2, 0.5x + 6) |
| | single value) | After mapping: (3, 11) |

The shuffling processing may be performing a shuffling operation on a group of values, where a mapping relationship between an original sequence and a shuffled sequence is known to the first device, and is unknown or known to the third device. For example, as shown in the following Table 3:

TABLE 3

| No | Physical meaning of the original sequence | Original sequence value |
|---|---|---|
| 1 | Measure a horizontal direction of a beam 1 | −70 |
| 2 | Measure a horizontal direction of a beam 2 | −20 |
| 3 | Measure a horizontal direction of a beam 3 | 20 |
| 4 | Measure a horizontal direction of a beam 4 | 70 |
| 5 | Measure a vertical direction of a beam 1 | 22.5 |
| 6 | Measure a vertical direction of a beam 2 | 112.5 |
| 7 | Measure a vertical direction of a beam 3 | 22.5 |
| 8 | Measure a vertical direction of a beam 4 | 112.5 |

Table 2 represents a mapping table of the original sequence and the physical meaning. In this way, after shuffling processing, 4 3 1 5 6 7 8 2 is obtained.

Mapping between a shuffled sequence obtained after shuffling processing and a physical meaning may be shown in the following Table 4:

TABLE 4

| No | Physical meaning of the original sequence | Original sequence value |
|---|---|---|
| 1 | Measure a horizontal direction of a beam 4 | 70 |
| 2 | Measure a horizontal direction of a beam 3 | 20 |
| 3 | Measure a horizontal direction of a beam 1 | −70 |
| 4 | Measure a vertical direction of a beam 1 | 22.5 |
| 5 | Measure a vertical direction of a beam 2 | 112.5 |
| 6 | Measure a vertical direction of a beam 3 | 22.5 |
| 7 | Measure a vertical direction of a beam 4 | 112.5 |
| 8 | Measure a horizontal direction of a beam 2 | −20 |

The quantization mapping processing may be performing quantization mapping on a single value, or mapping a beam direction to a virtual beam identifier, or mapping data to an identifier, where a mapping relationship is known to the first device, and is unknown or known to the third device. For example, a beam direction is mapped to a virtual beam identifier, or a virtual beam identifier is determined based on both a horizontal direction and a vertical direction. As shown in the following Table 5:

TABLE 5

| Horizontal direction | Vertical direction | Virtual beam |
|---|---|---|
| of a beam | of a beam | identifier |
| −70 | 22.5 | 0 |
| −70 | 110.5 | 1 |
| −20 | 22.5 | 2 |
| −20 | 110.5 | 3 |
| 20 | 22.5 | 4 |
| 20 | 110.5 | 5 |
| 70 | 22.5 | 6 |
| 70 | 110.5 | 7 |

As shown in Table 5, if a beam direction is a horizontal direction-20 and a vertical direction 110.5, a virtual beam identifier is 3.

Another mapping manner is performing mapping separately based on a horizontal direction and a vertical direction. As shown in the following Table 6 or Table 7:

TABLE 6

| Horizontal direction of a beam | Virtual beam indicator 1 |
|---|---|
| −70 | 0 |
| −20 | 1 |
| 20 | 2 |
| 70 | 3 |

TABLE 7

| Vertical direction of a | |
|---|---|
| beam | Virtual beam indicator 2 |
| 22.5 | 0 |
| 110.5 | 1 |

As shown in Table 6 and Table 7, if a beam direction is a horizontal direction −20 and a vertical direction 110.5, a virtual beam identifier is (1, 1).

In this embodiment of this application, a first device receives first information from a second device, where the first information includes at least one of the following: a first mapping relationship between an identifier of a mapping processing manner and a data collection requirement, and a first identifier, and the first identifier is used to indicate a target mapping processing manner; the first device determines the target mapping processing manner based on the first information; and the first device sends a first message to a third device, where the first message includes the first identifier and mapped data, and the mapped data is data obtained by processing collected data in the target mapping processing manner. In this way, direct data exposure can be avoided, thereby improving security of data transmission between communication devices.

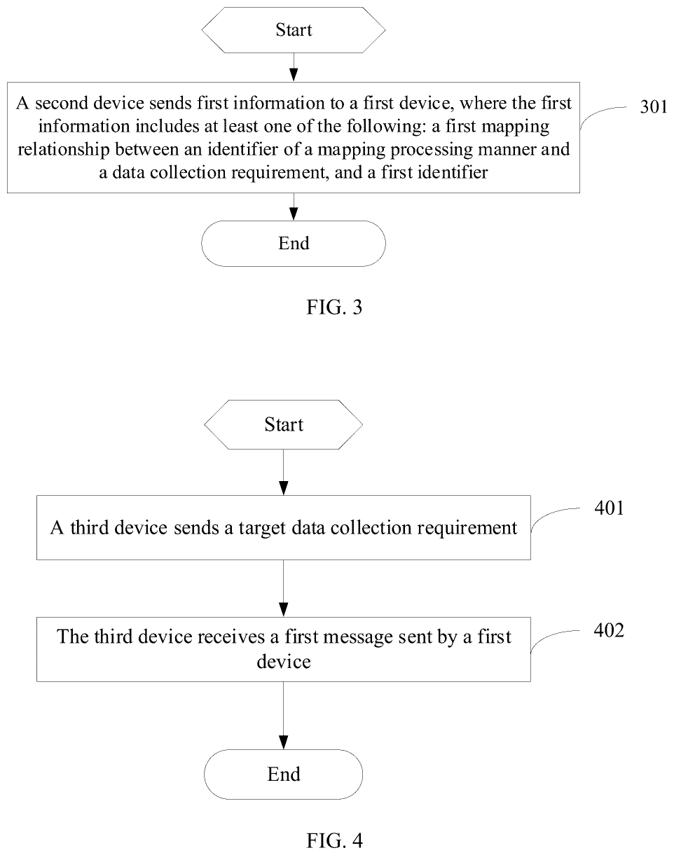

Referring to FIG. 3, FIG. 3 is a flowchart of another information transmission method according to an embodiment of this application. As shown in FIG. 3, the method includes the following steps.

Step 301: A second device sends first information to a first device, where the first information includes at least one of the following: a first mapping relationship between an identifier of a mapping processing manner and a data collection requirement, and a first identifier, and the first identifier is used to indicate a target mapping processing manner.

Optionally, the data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the data collection requirement is a data collection requirement of a third device; and
the data collection requirement is sent by the second device to the first device, or the data collection requirement is received by the first device and sent by the third device.

Optionally, in a case that the data collection requirement is received by the first device and sent by the third device, the first information includes the first mapping relationship; or
in a case that the data collection requirement is sent by the second device to the first device, the first information includes the first identifier, and the target mapping processing manner is determined by the second device.

Optionally, the method further includes:
sending, by the second device, a second mapping relationship between an identifier and a mapping processing manner to the first device.

Optionally, the target mapping processing manner includes at least one of the following:
offset processing;
scaling processing;
function transformation processing;
multidimensional mapping processing;
shuffling processing; and
quantization mapping processing.

Optionally, the method further includes:
receiving, by the second device, a second message sent by the third device, where the second message includes at least one of the following:
assistance information and capability indication information, where
the assistance information is used to assist the second device in determining the target mapping processing manner; and
the capability indication information is used to indicate a capability of the third device to process to-be-mapped data.

The assistance information may include the target data collection requirement.

The capability to process the to-be-mapped data may include at least one of the following:
a capability of whether to support processing of to-be-mapped data, a maximum supported quantity of pieces of data after mapping processing, and a supported value range after mapping processing.

The maximum supported quantity of pieces of data after mapping processing may be a maximum quantity that is of pieces of mapped data obtained after mapping processing and that is supported by the third device.

The supported value range after mapping processing may be at least one of a maximum supported value and a minimum supported value of mapped data after mapping processing.

In this implementation, the second device may determine the target mapping processing manner based on at least one of the assistance information and the capability indication information.

It should be noted that this embodiment is used as an implementation of the second device corresponding to the embodiment shown in FIG. 2. For a specific implementation of this embodiment, refer to the related descriptions of the embodiment shown in FIG. 2. To avoid repetition, details are not described in this embodiment again.

Referring to FIG. 4, FIG. 4 is a flowchart of another information transmission method according to an embodiment of this application. As shown in FIG. 4, the method includes the following steps.

Step 401: A third device sends a target data collection requirement.

Step 402: The third device receives a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

Optionally, the sending, by a third device, a target data collection requirement includes:
sending, by the third device, the target data collection requirement to the first device; or
sending, by the third device, the target data collection requirement to a second device.

Optionally, the target data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the method further includes:
generating, by the third device, a data set, where the data set includes mapped data with a same identifier.

The generating a data set may be generating one data set from mapped data that is with a same identifier and that is sent by one or more devices, that is, the one or more devices process collected data in a same mapping processing manner.

In this implementation, because the data set includes mapped data with a same identifier, a terminal performs unified application on data in the data set, thereby improving data processing performance of the terminal. For example, a same reasoning model is used to perform prediction on a transmit beam, a receive beam, a transceiver beam, or channel information based on data in the data set.

For example, a mapping processing manner is interacted between radio access network devices or core network devices, and mapping processing is performed on data in a same mapping processing manner, so that the terminal receives data from a plurality of network functions in a same mapping processing manner.

Optionally, the target mapping processing manner includes at least one of the following:
offset processing;
scaling processing;
function transformation processing;
multidimensional mapping processing;
shuffling processing; and
quantization mapping processing.

Optionally, the method further includes:
sending, by the third device, a second message to the second device, where the second message includes at least one of the following:
assistance information and capability indication information, where
the assistance information is used to assist the second device in determining the target mapping processing manner; and
the capability indication information is used to indicate a capability of the third device to process to-be-mapped data.

Optionally, the capability to process the to-be-mapped data includes at least one of the following:
a capability of whether to support processing of to-be-mapped data, a maximum supported quantity of pieces of data after mapping processing, and a supported value range after mapping processing.

It should be noted that this embodiment is used as an implementation of the third device corresponding to the embodiment shown in FIG. 2. For a specific implementation of this embodiment, refer to the related descriptions of the embodiment shown in FIG. 2. To avoid repetition, details are not described in this embodiment again.

The methods provided in the embodiments of this application are described as examples below by using a plurality of embodiments:

### Embodiment 1

In this embodiment, a first device is a radio access network device 1, a second device is a radio access network device 2, a third device is a terminal, and a data collection requirement is a data collection requirement of the third device. The following steps may be included:

Step 1: The radio access network device 2 sends a first mapping relationship to the radio access network device 1, that is, a mapping relationship between an identifier and a data collection requirement.

Step 2: The terminal sends a data collection requirement and a first capability to the radio access network device 1.

The data collection requirement includes: a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data (or referred to as a total quantity of pieces of information) is 32.

The first capability is a capability of the terminal to process to-be-mapped data, and a maximum supported quantity of pieces of data after mapping processing is 32. This indicates that a dimension expansion operation cannot be performed on 32 pieces of data, that is, the radio access network device 1 cannot perform multidimensional mapping processing on a single value.

Step 3: The radio access network device 1 determines a first identifier based on the collection requirement, the first capability, and the first mapping relationship, and then determines a target mapping processing manner based on the first identifier. For example, the first identifier indicates that mapping processing manners 1 and 5 are used, and indicates corresponding mapping processing parameters. 32 pieces of required data are mapped based on a mapping manner and corresponding parameter configuration.

Step 4: The radio access network device 1 sends the 32 pieces of data obtained after the mapping processing and the first identifier to the terminal.

Step 5: The terminal combines the first identifier with data that is from a plurality of radio access network devices or a same radio access network device and whose data bits are the same, to generate a data set.

### Embodiment 2

In this embodiment, a first device is a radio access network device 1, a second device is a radio access network device 2, a third device is a terminal, and a data collection requirement is a data collection requirement forwarded by the second device to the third device. The following steps are included:

Step 1: The radio access network device 2 sends a second mapping relationship to the radio access network device 1, that is, a mapping relationship between an identifier and a mapping processing manner.

Step 2: The terminal sends a data collection requirement and a first capability to the radio access network device 2. The data collection requirement includes a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data is 32.

The first capability is a capability of the terminal to process to-be-mapped data, and a maximum supported quantity of pieces of data after mapping processing is 32. This indicates that a dimension expansion operation cannot be performed on 32 pieces of data, that is, multidimensional mapping privacy processing cannot be performed on a single value.

Step 3: The radio access network device 2 determines a target mapping processing manner based on the data collection requirement and the first capability, and maps to a first identifier.

Step 4: The radio access network device 2 sends the first identifier and the data collection requirement to the radio access network device 1.

Step 5: The radio access network device 1 determines the target mapping processing manner based on the first identifier and the second mapping relationship.

For example, the first identifier indicates that mapping processing manners 1 and 5 are used, and indicates corresponding mapping processing parameters. Mapping processing is performed on 32 pieces of required data based on a mapping manner and a corresponding parameter configuration.

Step 6: The radio access network device 1 sends the 32 pieces of data obtained after the mapping processing and the first identifier to the UE.

Step 7: The terminal combines the first identifier with data that is from a plurality of radio access network devices or a same radio access network device and whose data bits are the same, to generate a data set.

### Embodiment 3

In this embodiment, a first device is a radio access network device, a second device is a core network function, a third device is a terminal, and a data collection requirement is a data collection requirement of the third device. The following steps are included:

Step 1: The core network function sends a first mapping relationship to the radio access network device, that is, a mapping relationship between an identifier and a data collection requirement.

Step 2: The terminal sends a data collection requirement and a first capability to the radio access network device.

The data collection requirement includes a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data is 32.

The first capability is a capability of the terminal to process to-be-mapped data, and a maximum supported quantity of pieces of data after mapping processing is 32. This indicates that a dimension expansion operation cannot be performed on 32 pieces of data, that is, multidimensional mapping privacy processing cannot be performed on a single value.

Step 3: The radio access network device determines a first identifier based on the data collection requirement, the first capability, and the first mapping relationship, and then determines a target mapping processing manner based on the first identifier. For example, the first identifier indicates that mapping processing manners 1 and 5 are used, and indicates corresponding mapping processing parameters. Privacy processing is performed on 32 pieces of required data based on a mapping manner and a corresponding parameter configuration.

Step 4: The radio access network device sends the 32 pieces of data obtained after the privacy processing and the first identifier to the terminal.

Step 5: The terminal combines the first identifier with data that is from a plurality of radio access network devices or a same radio access network device and whose data bits are the same, to generate a data set.

### Embodiment 4

In this embodiment, a first device is a radio access network device, a second device is a core network function, a third device is a terminal, and a data collection requirement is a data collection requirement forwarded by the second device to the third device. The following steps are included:

Step 1: The core network function sends a second mapping relationship to the radio access network device, that is, a mapping relationship between an identifier and a mapping processing manner.

Step 2: The terminal sends a data collection requirement and a first capability (for example, carried through a measurement configuration) to the core network function.

The data collection requirement includes a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data is 32.

The first capability is a capability of the terminal to process to-be-mapped data, and a maximum supported quantity of pieces of data after mapping processing is 32. This indicates that a dimension expansion operation cannot be performed on 32 pieces of data, that is, multidimensional mapping privacy processing cannot be performed on a single value.

Step 3: The core network function determines a target mapping processing manner based on the data collection requirement and the first capability, and maps to a first identifier.

Step 4: The core network function sends the first identifier and the data collection requirement to the radio access network device.

Step 5: The radio access network device determines the target mapping processing manner based on the first identifier and the second mapping relationship.

For example, the first identifier indicates that mapping processing manners 1 and 5 are used, and indicates corresponding mapping processing parameters. Privacy processing is performed on 32 pieces of required data based on a mapping manner and a corresponding parameter configuration.

Step 6: The radio access network device sends the 32 pieces of data obtained after the mapping processing and the first identifier to the terminal.

Step 7: The terminal combines the first identifier with data that is from a plurality of radio access network devices or a same radio access network device and whose data bits are the same, to generate a data set.

### Embodiment 5

In this embodiment, a first device is a core network function 1, a second device is a core network function 2, a third device is a terminal, and a data collection requirement is a data collection requirement of the third device. The following steps are included:

Step 1: The core network function 2 sends a first mapping relationship to the core network function 1, that is, a mapping relationship between an identifier and a data collection requirement.

Step 2: The UE sends a data collection requirement and a first capability to the core network function 1.

The data collection requirement includes a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data is 32.

The first capability is a capability of the terminal to process to-be-mapped data, and a maximum supported quantity of pieces of data after mapping processing is 32. This indicates that a dimension expansion operation cannot be performed on 32 pieces of data, that is, multidimensional mapping privacy processing cannot be performed on a single value.

Step 3: The core network function 1 determines a first identifier based on the data collection requirement, the first capability, and the first mapping relationship, and then determines a target mapping processing manner based on the first identifier. For example, the first identifier indicates that mapping processing manners 1 and 5 are used, and indicates corresponding mapping processing parameters. 32 pieces of required data are mapped based on a mapping manner and corresponding parameter configuration.

Step 4: The core network function 1 sends the 32 pieces of data obtained after the mapping processing and the first identifier to the terminal.

Step 5: The terminal combines the first identifier with data that is from a plurality of core network functions or a same core network function and whose data bits are the same, to generate a data set.

### Embodiment 6

In this embodiment, a first device is a core network function 1, a second device is a core network function 2, a third device is a terminal, and a data collection requirement is a data collection requirement forwarded by the second device to the third device. The following steps are included:

Step 1: The core network function 2 sends a second mapping relationship to the core network function 1, that is, a mapping relationship between an identifier and a mapping processing manner.

Step 2: The terminal sends a data collection requirement and a first capability to the core network function 2.

The data collection requirement includes a horizontal beam direction of a beam, a vertical beam direction of a beam, a 3 dB beam width in a horizontal direction, and a 3 dB beam width in a vertical direction, where a quantity of pieces of to-be-collected data is 8, a quantity of reference signal resources configured by a base station is consistent with the collection quantity, and a total quantity of pieces of data is 32.

The first capability is a capability of the terminal to process to-be-mapped data, and a maximum supported quantity of pieces of data after mapping processing is 32. This indicates that a dimension expansion operation cannot be performed on 32 pieces of data, that is, multidimensional mapping privacy processing cannot be performed on a single value.

Step 3: The core network function 2 determines a target mapping processing manner based on the data collection requirement and the first capability, and maps to a first identifier.

Step 4: The core network function 2 sends the first identifier and the data collection requirement to the core network function 1.

Step 5: The core network function 1 determines the target mapping processing manner based on the first identifier and the second mapping relationship.

For example, the first identifier indicates that mapping processing manners 1 and 5 are used, and indicates corresponding mapping processing parameters. Privacy processing is performed on 32 pieces of required data based on a mapping manner and a corresponding parameter configuration.

Step 6: The core network function 1 sends the 32 pieces of data obtained after the mapping processing and the first identifier to the terminal.

Step 7: The terminal combines the first identifier with data that is from a plurality of core network functions or a same core network function and whose data bits are the same, to generate a data set.

In this embodiment of this application, an identifier of a mapping processing manner is interacted between radio access network devices or core network functions, and mapping processing is performed on data in a same mapping processing manner, so that a terminal collects sensitive data on which same mapping processing is performed.

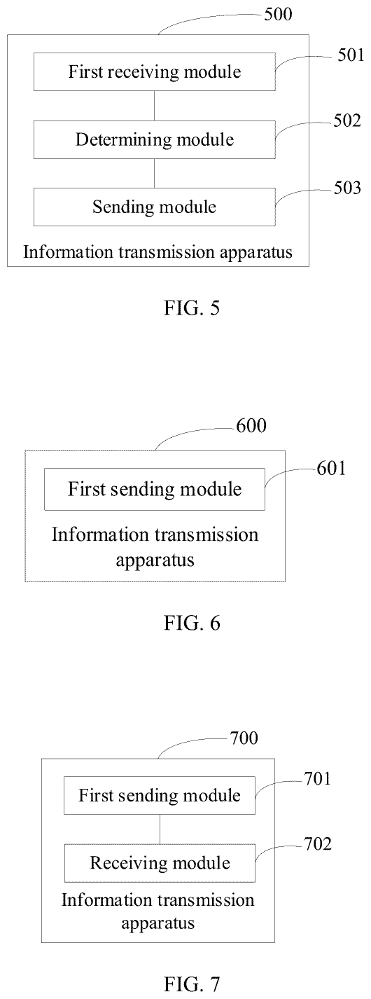

Referring to FIG. 5, FIG. 5 is a structural diagram of an information transmission apparatus according to an embodiment of this application. As shown in FIG. 5, the information transmission apparatus 500 includes:
a first receiving module 501, configured to receive first information from a second device, where the first information includes at least one of the following: a first mapping relationship between an identifier of a mapping processing manner and a data collection requirement, and a first identifier, and the first identifier is used to indicate a target mapping processing manner;
a determining module 502, configured to determine the target mapping processing manner based on the first information; and
a sending module 503, configured to send a first message to a third device, where the first message includes the first identifier and mapped data, and the mapped data is data obtained by processing collected data in the target mapping processing manner.

Optionally, in a case that the first information includes the first mapping relationship, the determining module 502 is configured to:
determine the target mapping processing manner based on the first mapping relationship and a target data collection requirement, where the target data collection requirement is a data collection requirement of to-be-collected data.

Optionally, the target data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the target data collection requirement is a data collection requirement of the third device; and
the target data collection requirement is received by the first device and sent by the third device, or the data collection requirement is received by the first device and sent by the second device.

Optionally, in a case that the data collection requirement is received by the first device and sent by the third device, the first information includes the first mapping relationship; or
in a case that the data collection requirement is received by the first device and sent by the second device, the first information includes the first identifier.

Optionally, the apparatus further includes:
a second receiving module, configured to receive a second mapping relationship, sent by the second device, between an identifier and a mapping processing manner.

Optionally, the target mapping processing manner includes at least one of the following:
offset processing;
scaling processing;
function transformation processing;
multidimensional mapping processing;
shuffling processing; and
quantization mapping processing.

The foregoing information transmission apparatus can improve security of data transmission between communication devices.

The information transmission apparatus in this embodiment of this application may be an electronic device, for example, an electronic device with an operating system, or may be a component in the electronic device, for example, an integrated circuit or a chip. The electronic device may be a terminal or a network side device.

The information sending apparatus provided in this embodiment of this application can implement the processes implemented in the method embodiment shown in FIG. 2, and achieve a same technical effect. To avoid repetition, details are not described herein again.

Referring to FIG. 6, FIG. 6 is a structural diagram of an information transmission apparatus according to an embodiment of this application. As shown in FIG. 6, the information transmission apparatus 600 includes:
a first sending module 601, configured to send first information to a first device, where the first information includes at least one of the following: a first mapping relationship between an identifier of a mapping processing manner and a data collection requirement, and a first identifier, and the first identifier is used to indicate a target mapping processing manner.

Optionally, the data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the data collection requirement is a data collection requirement of a third device; and
the data collection requirement is sent by the second device to the first device, or the data collection requirement is received by the first device and sent by the third device.

Optionally, in a case that the data collection requirement is received by the first device and sent by the third device, the first information includes the first mapping relationship; or
in a case that the data collection requirement is sent by the second device to the first device, the first information includes the first identifier, and the target mapping processing manner is determined by the second device.

Optionally, the apparatus further includes:
a second sending module, configured to send a second mapping relationship between an identifier and a mapping processing manner to the first device.

Optionally, the target mapping processing manner includes at least one of the following:
offset processing;
scaling processing;
function transformation processing;
multidimensional mapping processing;
shuffling processing; and
quantization mapping processing.

Optionally, the apparatus further includes:
a receiving module, configured to receive a second message sent by the third device, where the second message includes at least one of the following:
assistance information and capability indication information, where
the assistance information is used to assist the second device in determining the target mapping processing manner; and
the capability indication information is used to indicate a capability of the third device to process to-be-mapped data.

Optionally, the capability to process the to-be-mapped data includes at least one of the following:
a capability of whether to support processing of to-be-mapped data, a maximum supported quantity of pieces of data after mapping processing, and a supported value range after mapping processing. The foregoing information transmission apparatus can improve security of data transmission between communication devices.

The information sending apparatus in this embodiment of this application may be an electronic device, for example, an electronic device with an operating system, or may be a component in the electronic device, for example, an integrated circuit or a chip. The electronic device may be a terminal or a network side device.

The information sending apparatus provided in this embodiment of this application can implement the processes implemented in the method embodiment shown in FIG. 3, and achieve a same technical effect. To avoid repetition, details are not described herein again.

Referring to FIG. 7, FIG. 7 is a structural diagram of an information transmission apparatus according to an embodiment of this application. As shown in FIG. 7, the information transmission apparatus 700 includes:
a first sending module 701, configured to send a target data collection requirement; and
a receiving module 702, configured to receive a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

Optionally, the sending, by a third device, a target data collection requirement includes:
sending, by the third device, the target data collection requirement to the first device; or
sending, by the third device, the target data collection requirement to a second device.

Optionally, the target data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the apparatus further includes:
a generating module, configured to generate a data set, where the data set includes mapped data with a same identifier.

Optionally, the target mapping processing manner includes at least one of the following:
offset processing;
scaling processing;
function transformation processing;
multidimensional mapping processing;
shuffling processing; and
quantization mapping processing.

Optionally, the apparatus further includes:
a second sending module, configured to send a second message to the second device, where the second message includes at least one of the following:
assistance information and capability indication information, where
the assistance information is used to assist the second device in determining the target mapping processing manner; and
the capability indication information is used to indicate a capability of the third device to process to-be-mapped data.

Optionally, the capability to process the to-be-mapped data includes at least one of the following:
a capability of whether to support processing of to-be-mapped data, a maximum supported quantity of pieces of data after mapping processing, and a supported value range after mapping processing.

The foregoing information transmission apparatus can improve security of data transmission between communication devices.

The information transmission apparatus in this embodiment of this application may be an electronic device, for example, an electronic device with an operating system, or may be a component in the electronic device, for example, an integrated circuit or a chip. For example, the electronic device may be a terminal, or may be another device other than the terminal. For example, the terminal may include but is not limited to the type of the terminal listed in this embodiment of this application, and the another device may be a server, a network attached storage (NAS), or the like. This is not specifically limited in this embodiment of this application.

The information transmission apparatus provided in this embodiment of this application can implement the processes implemented in the method embodiment shown in FIG. 4, and achieve a same technical effect. To avoid repetition, details are not described herein again.

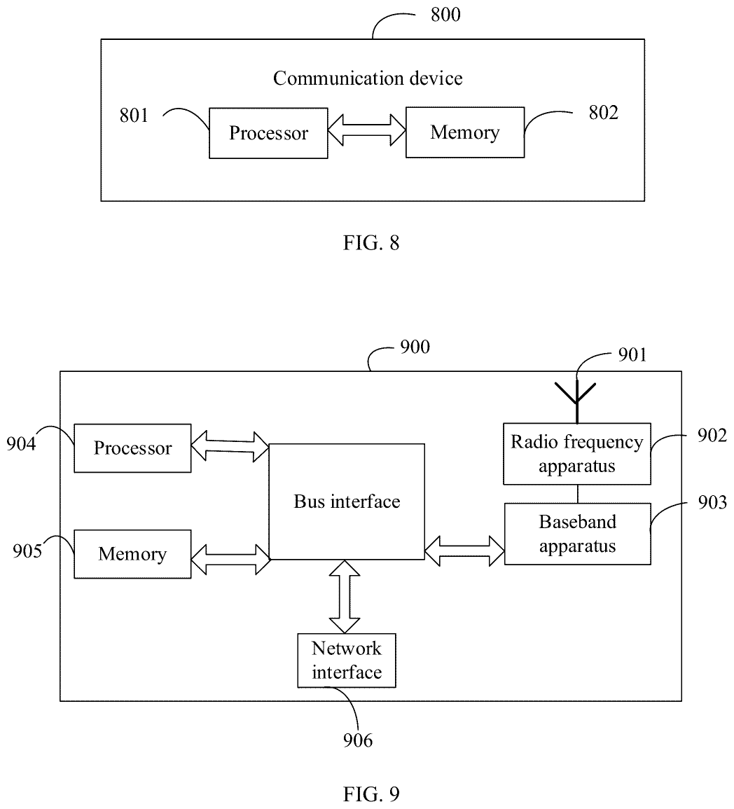

Optionally, as shown in FIG. 8, an embodiment of this application further provides a communication device 800, including a processor 801 and a memory 802. The memory 802 stores a program or an instruction that can be run on the processor 801. For example, when the communication device 800 is a first device, the program or the instruction is executed by the processor 801 to implement the steps of the foregoing information transmission method embodiment, and a same technical effect can be achieved. When the communication device 800 is a second device, the program or the instruction is executed by the processor 801 to implement the steps of the foregoing information sending method embodiment, and a same technical effect can be achieved. To avoid repetition, details are not described herein again.

An embodiment of this application further provides a communication device, including a processor and a communication interface. The communication interface is configured to receive first information from a second device, where the first information includes at least one of the following: a first mapping relationship between an identifier of a mapping processing manner and a data collection requirement, and a first identifier, and the first identifier is used to indicate a target mapping processing manner; the processor is configured to determine the target mapping processing manner based on the first information; and the communication interface is further configured to send a first message to a third device, where the first message includes the first identifier and mapped data, and the mapped data is data obtained by processing collected data in the target mapping processing manner. This embodiment of the communication device corresponds to the foregoing information transmission method embodiment on the first device side. Each implementation process and implementation of the foregoing method embodiment may be applicable to this embodiment of the communication device, and a same technical effect can be achieved.

Specifically, an embodiment of this application further provides a communication device. As shown in FIG. 9, the communication device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information by using the antenna 901, and sends the received information to the baseband apparatus 903 for processing. In a downlink direction, the baseband apparatus 903 processes information that needs to be sent, and sends processed information to the radio frequency apparatus 902. The radio frequency apparatus 902 processes the received information, and sends processed information by using the antenna 901.

In the foregoing embodiment, the method performed by the communication device may be implemented in the baseband apparatus 903. The baseband apparatus 903 includes a baseband processor.

The baseband apparatus 903 may include, for example, at least one baseband board, where a plurality of chips are disposed on the baseband board. As shown in FIG. 9, one chip, for example, the baseband processor, is connected to the memory 905 through a bus interface, to invoke a program in the memory 905 to perform the operations of the network device shown in the foregoing method embodiment.

The communication device may further include a network interface 906, and the interface is, for example, a common public radio interface (CPRI).

Specifically, the communication device 900 in this embodiment of the present invention further includes an instruction or a program that is stored in the memory 905 and that can be run on the processor 904. The processor 904 invokes the instruction or the program in the memory 905 to execute the method executed by the modules shown in FIG. 5, and a same technical effect is achieved. To avoid repetition, details are not described herein again.

In this embodiment, the foregoing communication device is a first device, and an example in which the first device is a radio access network device is used for description.

The radio frequency apparatus 902 is configured to receive first information from a second device, where the first information includes at least one of the following: a first mapping relationship between an identifier of a mapping processing manner and a data collection requirement, and a first identifier, and the first identifier is used to indicate a target mapping processing manner.

The processor 904 is configured to determine the target mapping processing manner based on the first information.

The radio frequency apparatus 902 is further configured to send a first message to a third device, where the first message includes the first identifier and mapped data, and the mapped data is data obtained by processing collected data in the target mapping processing manner.

Optionally, in a case that the first information includes the first mapping relationship, the determining the target mapping processing manner includes:
determining the target mapping processing manner based on the first mapping relationship and a target data collection requirement, where the target data collection requirement is a data collection requirement of to-be-collected data.

Optionally, the target data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the target data collection requirement is a data collection requirement of the third device; and
the target data collection requirement is received by the first device and sent by the third device, or the data collection requirement is received by the first device and sent by the second device.

Optionally, in a case that the data collection requirement is received by the first device and sent by the third device, the first information includes the first mapping relationship; or
in a case that the data collection requirement is received by the first device and sent by the second device, the first information includes the first identifier.

Optionally, the radio frequency apparatus 902 is further configured to:
receive a second mapping relationship, sent by the second device, between an identifier and a mapping processing manner.

Optionally, the target mapping processing manner includes at least one of the following:
offset processing;
scaling processing;
function transformation processing;
multidimensional mapping processing;
shuffling processing; and
quantization mapping processing.

The foregoing communication device can improve security of data transmission between communication devices.

An embodiment of this application further provides a communication device, including a processor and a communication interface. The communication interface is configured to send first information to a first device, where the first information includes at least one of the following: a first mapping relationship between an identifier of a mapping processing manner and a data collection requirement, and a first identifier, and the first identifier is used to indicate a target mapping processing manner. This embodiment of the communication device corresponds to the foregoing information transmission method embodiment on the second device side. Each implementation process and implementation of the foregoing method embodiment may be applicable to this embodiment of the communication device, and a same technical effect can be achieved.

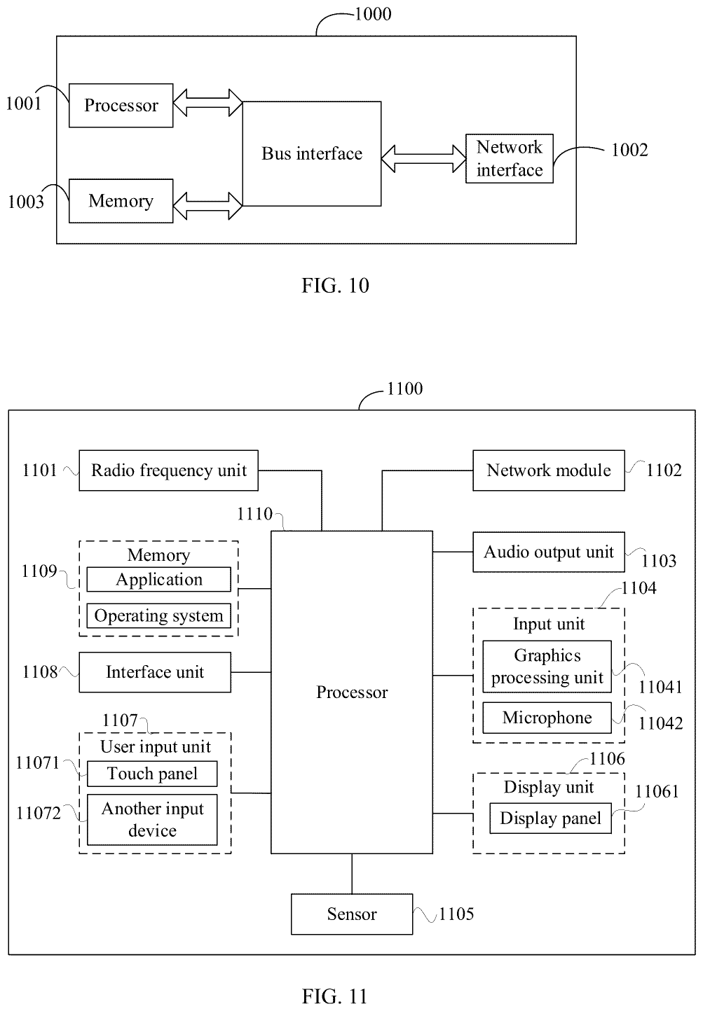

Specifically, an embodiment of this application further provides a communication device. As shown in FIG. 10, the communication device 1000 includes a processor 1001, a network interface 1002, and a memory 1003. The network interface 1002 is, for example, a common public radio interface (CPRI).

Specifically, the communication device 1000 in this embodiment of this application further includes an instruction or a program that is stored in the memory 1003 and that can be run on the processor 1001. The processor 1001 invokes the instruction or the program in the memory 1003 to execute the method executed by the modules shown in FIG. 6, and a same technical effect is achieved. To avoid repetition, details are not described herein again.

In this embodiment, the foregoing communication device is a second device, and an example in which the second device is a core network device is used for description.

The network interface 1002 is configured to send first information to a first device, where the first information includes at least one of the following: a first mapping relationship between an identifier of a mapping processing manner and a data collection requirement, and a first identifier, and the first identifier is used to indicate a target mapping processing manner.

Optionally, the data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the data collection requirement is a data collection requirement of a third device; and
the data collection requirement is sent by the second device to the first device, or the data collection requirement is received by the first device and sent by the third device.

Optionally, in a case that the data collection requirement is received by the first device and sent by the third device, the first information includes the first mapping relationship; or
in a case that the data collection requirement is sent by the second device to the first device, the first information includes the first identifier, and the target mapping processing manner is determined by the second device.

Optionally, the network interface 1002 is further configured to:
send a second mapping relationship between an identifier and a mapping processing manner to the first device.

Optionally, the target mapping processing manner includes at least one of the following:
offset processing;
scaling processing;
function transformation processing;
multidimensional mapping processing;
shuffling processing; and
quantization mapping processing.

Optionally, the network interface 1002 is further configured to:
receive a second message sent by the third device, where the second message includes at least one of the following:
assistance information and capability indication information, where
the assistance information is used to assist the second device in determining the target mapping processing manner; and
the capability indication information is used to indicate a capability of the third device to process to-be-mapped data.

Optionally, the capability to process the to-be-mapped data includes at least one of the following:
a capability of whether to support processing of to-be-mapped data, a maximum supported quantity of pieces of data after mapping processing, and a supported value range after mapping processing.

The foregoing communication device can improve security of data transmission between communication devices.

An embodiment of this application further provides a communication device, including a processor and a communication interface. The communication interface is configured to: send a target data collection requirement; and receive a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data. This embodiment of the communication device corresponds to the foregoing information transmission method embodiment on the third device side. Each implementation process and implementation of the foregoing method embodiment may be applicable to this embodiment of the communication device, and a same technical effect can be achieved.

Specifically, FIG. 11 is a schematic structural diagram of hardware of a communication device according to an embodiment of this application.

A communication device 1100 includes but is not limited to components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the communication device 1100 may further include the power supply (for example, a battery) that supplies power to each component. The power supply may be logically connected to the processor 1110 by using a power supply management system, so as to manage functions such as charging, discharging, and power consumption by using the power supply management system. The structure of the communication device shown in FIG. 11 does not constitute a limitation on the communication device, and the communication device may include more or fewer components than those shown in the figure, or combine some components, or have different component arrangements. Details are not described herein again.

It should be understood that, in this embodiment of this application, the input unit 1104 may include a graphics processing unit (GPU) 11041 and a microphone 11042, and the graphics processing unit 11041 processes image data of a still image or a video that is obtained by an image capturing apparatus (for example, a camera) in a video capturing mode or an image capturing mode. The display unit 1106 may include a display panel 11061. The display panel 11061 may be configured in a form such as a liquid crystal display or an organic light-emitting diode. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Usually, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 1109 in this embodiment of this application includes but is not limited to these memories and a memory of any other proper type.

The processor 1110 may include one or more processing units. Optionally, an application processor and a modem processor are integrated into the processor 1110. The application processor mainly processes an operating system, a user interface, an application, and the like. The modem processor mainly processes a wireless communication signal, for example, a baseband processor. It can be understood that, alternatively, the modem processor may not be integrated into the processor 1110.

In this embodiment, the foregoing communication device is a third device, and an example in which the third device is a terminal is used for description.

The radio frequency unit 1101 is configured to: send a target data collection requirement; and receive a first message sent by a first device, where the first message includes a first identifier and mapped data, the first identifier is used to indicate a target mapping processing manner, the mapped data is data obtained by processing collected data in the target mapping processing manner, and the target data collection requirement is a data collection requirement of to-be-collected data.

Optionally, the sending a target data collection requirement includes:
sending the target data collection requirement to the first device; or
sending the target data collection requirement to a second device.

Optionally, the target data collection requirement includes at least one of the following:
a to-be-collected data object and a quantity of pieces of to-be-collected data.

Optionally, the to-be-collected data object includes at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

Optionally, the processor 1110 is configured to:
generate a data set, where the data set includes mapped data with a same identifier.

Optionally, the target mapping processing manner includes at least one of the following:
offset processing;
scaling processing;
function transformation processing;
multidimensional mapping processing;
shuffling processing; and
quantization mapping processing.

Optionally, the radio frequency unit 1101 is further configured to:
send a second message to the second device, where the second message includes at least one of the following:
assistance information and capability indication information, where
the assistance information is used to assist the second device in determining the target mapping processing manner; and
the capability indication information is used to indicate a capability of the third device to process to-be-mapped data.

Optionally, the capability to process the to-be-mapped data includes at least one of the following:
a capability of whether to support processing of to-be-mapped data, a maximum supported quantity of pieces of data after mapping processing, and a supported value range after mapping processing.

The foregoing communication device can improve security of data transmission between communication devices.

An embodiment of this application further provides a readable storage medium, where the readable storage medium stores a program or an instruction, and the program or the instruction is executed by a processor to implement the steps of the foregoing information transmission method provided in the embodiments of this application.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information transmission method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing information transmission method embodiment, and a same technical effect can be achieved. To avoid repetition, details are not described herein again.

An embodiment of this application further provides an information transmission system, including a first device, a second device, and a third device. The first device may be configured to execute the steps of the information transmission method on the first device side provided in the embodiments of this application, the second device may be configured to execute the steps of the information transmission method on the second device side provided in the embodiments of this application, and the third device may be configured to execute the steps of the information transmission method on the third device side provided in the embodiments of this application.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by software in addition to a necessary general hardware platform or by hardware. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An information transmission method, comprising:
receiving, by a first device, first information from a second device, wherein the first information comprises a first identifier, and the first identifier is used to indicate a target mapping processing manner;
determining, by the first device, the target mapping processing manner based on the first information; and
sending, by the first device, a first message to a third device, wherein the first message comprises the first identifier;
wherein the first device is a terminal, the second device is a network side device, and the third device is a network side device.

2. The method according to claim 1, wherein the first information further comprises: a mapped data, and the mapped data is data obtained by processing collected data in the target mapping processing manner.

3. The method according to claim 1, wherein the first information further comprises a first mapping relationship between an identifier of a mapping processing manner and a data collection requirement, the determining the target mapping processing manner comprises:
determining the target mapping processing manner based on the first mapping relationship and a target data collection requirement, wherein the target data collection requirement is a data collection requirement of to-be-collected data;
wherein the target data collection requirement comprises at least one of the following:
a to-be-collected data object or a quantity of pieces of to-be-collected data.

4. The method according to claim 3, wherein the to-be-collected data object comprises at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; or
non-line-of-sight NLOS distribution information of a cell.

5. The method according to claim 3, wherein the target data collection requirement is a data collection requirement of the third device; and
the target data collection requirement is received by the first device and sent by the third device, or the data collection requirement is received by the first device and sent by the second device.

6. The method according to claim 1, wherein the target mapping processing manner comprises at least one of the following:
offset processing;
scaling processing;
function transformation processing;
multidimensional mapping processing;
shuffling processing; or
quantization mapping processing.

7. An information transmission method, comprising:
sending, by a second device, first information to a first device, wherein the first information comprises a first identifier, and the first identifier is used to indicate a target mapping processing manner;
wherein the second device is a network side device, and the first device is a terminal.

8. The method according to claim 7, wherein the first information further comprises a first mapping relationship between an identifier of a mapping processing manner and a data collection requirement, and the data collection requirement comprises at least one of the following:
a to-be-collected data object or a quantity of pieces of to-be-collected data.

9. The method according to claim 8, wherein the to-be-collected data object comprises at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; or
non-line-of-sight NLOS distribution information of a cell.

10. The method according to claim 8, wherein the data collection requirement is a data collection requirement of a third device; and
the data collection requirement is sent by the second device to the first device, or the data collection requirement is received by the first device and sent by the third device.

11. The method according to claim 7, wherein the target mapping processing manner comprises at least one of the following:
offset processing;
scaling processing;
function transformation processing;
multidimensional mapping processing;
shuffling processing; or
quantization mapping processing.

12. The method according to claim 7, wherein the method further comprises:
receiving, by the second device, a second message sent by the third device, wherein the second message comprises at least one of the following:
assistance information or capability indication information, wherein
the assistance information is used to assist the second device in determining the target mapping processing manner; and
the capability indication information is used to indicate a capability of the third device to process to-be-mapped data;
wherein the third device is a network side device.

13. The method according to claim 12, wherein the capability to process the to-be-mapped data comprises at least one of the following:
a capability of whether to support processing of to-be-mapped data, a maximum supported quantity of pieces of data after mapping processing, or a supported value range after mapping processing.

14. An information transmission method, comprising:
sending, by a third device, a target data collection requirement, the target data collection requirement is a data collection requirement of to-be-collected data; and
receiving, by the third device, a first message sent by a first device, wherein the first message comprises a first identifier and mapped data corresponding to the first identifier;
wherein the third device is a terminal, and the first device is a network side device.

15. The method according to claim 14, wherein the sending, by a third device, a target data collection requirement comprises:
sending, by the third device, the target data collection requirement to the first device.

16. The method according to claim 14, wherein the target data collection requirement comprises at least one of the following:
a to-be-collected data object and a quantity of pieces of to-be-collected data.

17. The method according to claim 16, wherein the to-be-collected data object comprises at least one of the following:
a horizontal beam direction of a beam;
a vertical beam direction of a beam;
a width of a beam in a horizontal direction;
a width of a beam in a vertical direction;
a beam gain;
antenna direction information;
a moving speed of a terminal;
location information of a terminal;
location information of a cell;
line-of-sight LOS distribution information of a cell; and
non-line-of-sight NLOS distribution information of a cell.

18. A communication device, comprising a processor and a memory, wherein the memory stores a program or an instruction that can be run on the processor, and the program or the instruction is executed by the processor to implement the steps of the information transmission method according to claim 1.

19. A communication device, comprising a processor and a memory, wherein the memory stores a program or an instruction that can be run on the processor, and the program or the instruction is executed by the processor to implement the steps of the information transmission method according to claim 7.

20. A communication device, comprising a processor and a memory, wherein the memory stores a program or an instruction that can be run on the processor, and the program or the instruction is executed by the processor to implement the steps of the information transmission method according to claim 14.
